(19) United States
(12) Patent Application Publication
(10) Pub. No.: US 2016/0232684 A1
(43) Pub. Date: Aug. 11, 2016

(54) MOTION COMPENSATION METHOD AND APPARATUS FOR DEPTH IMAGES

(71) Applicants: Alexander Borisovich KHOLODENKO, Moscow (RU); Denis Vladimirovich PARKHOMENKO, Moscow (RU); Alexander Alexandrovich PETYUSHKO, Moscow (RU); Denis Vasilievich PARFENOV, Moscow (RU); Deniss ZAICEVS, Moscow (RU); LSI CORPORATION, San Jose, CA (US)

(72) Inventors: Alexander B. Kholodenko, Moscow (RU); Denis V. Parkhomenko, Moscow (RU); Alexander A. Petyushko, Moscow (RU); Denis V. Parfenov, Moscow (RU); Denis V. Zaytsev, Moscow (RU)

(21) Appl. No.: 14/353,171

(22) PCT Filed: Oct. 18, 2013
(86) PCT No.: PCT/RU2013/000921

§ 371 Date: Apr. 21, 2014

(51) Int. Cl. G06T 7/20; H04N 13/02

(52) U.S. Cl. CPC G06T 7/2086; H04N 13/0203; G06T 2207/10028

(57) ABSTRACT

In one embodiment, an image processor is configured to obtain a plurality of phase images for each of first and second depth frames. For each of a plurality of pixels of a given one of the phase images of the first depth frame, the image processor determines an amount of movement of a point of an imaged scene between the pixel of the given phase image and a pixel of a corresponding phase image of the second depth frame, and adjusts pixel values of respective other phase images of the first depth frame based on the determined amount of movement. A motion compensated first depth image is generated utilizing the given phase image and the adjusted other phase images of the first depth frame. Movement of a point of the imaged scene is determined, for example, between pixels of respective n-th phase images of the first and second depth frames.

### FIELD

The field relates generally to image processing, and more particularly to techniques for providing motion compensation in depth images.

### BACKGROUND

Depth images are commonly utilized in a wide variety of machine vision applications including, for example, gesture recognition systems and robotic control systems. A depth image may be generated directly using a depth imager such as a structured light (SL) camera or a time of flight (ToF) camera. Such cameras may provide both depth information and intensity information, in the form of respective depth and amplitude images. It is also possible to generate a depth image as a three-dimensional (3D) image computed from multiple two-dimensional (2D) images captured by respective cameras arranged such that each camera has a different view of an imaged scene. Such computed 3D images are intended to be encompassed by the general term “depth image” as used herein.

A significant problem that arises when processing depth images relates to motion blur and other types of motion artifacts attributable to fast movement of objects within an imaged scene. In this context, “fast” refers to movement that occurs on a time scale that is less than the time between generation of consecutive depth images at a given frame rate. Although a number of conventional techniques attempt to compensate for motion artifacts attributable to fast movement of objects, these techniques can be deficient, particularly with respect to depth images that are generated using sequences of phase images captured at different instants in time, such as those typically generated by a ToF camera.

### SUMMARY

In one embodiment, an image processor is configured to obtain a plurality of phase images for each of first and second depth frames. For each of a plurality of pixels of a given one of the phase images of the first depth frame, the image processor determines an amount of movement of a point of an imaged scene between the pixel of the given phase image of the first depth frame and a pixel of a corresponding phase image of the second depth frame, and adjusts pixel values of respective other phase images of the first depth frame based on the determined amount of movement. A motion compensated first depth image is generated utilizing the given phase image and the adjusted other phase images of the first depth frame.

By way of example only, movement of a point of the imaged scene may be determined between pixels of respective n-th phase images of the first and second depth frames. The image processor may be implemented in a depth imager such as a ToF camera or in another type of processing device.

Other embodiments of the invention include but are not limited to methods, apparatus, systems, processing devices, integrated circuits, and computer-readable storage media having computer program code embodied therein.

### BRIEF DESCRIPTION OF THE DRAWINGS

FIG. 1 is a block diagram of a depth imager comprising an image processor configured to implement motion compensation in conjunction with generation of depth images in an illustrative embodiment.

FIG. 2 is a flow diagram of an illustrative embodiment of a motion compensation process implemented in the image processor of FIG. 1.

FIG. 3 illustrates movement of an exemplary point in an imaged scene over multiple sequential capture times for respective phase images of a depth frame.

FIG. 4 illustrates adjustment of pixel values in the FIG. 1 image processor using the FIG. 2 process to compensate for motion of the type shown in FIG. 3.

FIG. 5 illustrates sequential capture of multiple phase images for each of two consecutive depth frames.

FIG. 6 is a graphical plot showing an exemplary movement direction for a given point of an imaged scene as a function of time over the multiple phase images of the consecutive depth frames of FIG. 5.

### DETAILED DESCRIPTION

Embodiments of the invention will be illustrated herein in conjunction with exemplary depth imagers that include respective image processors each configured to provide motion compensation in depth images generated by the corresponding depth imager. It should be understood, however, that embodiments of the invention are more generally applicable to any image processing system or associated device or technique in which it is desirable to provide motion compensation in depth images.

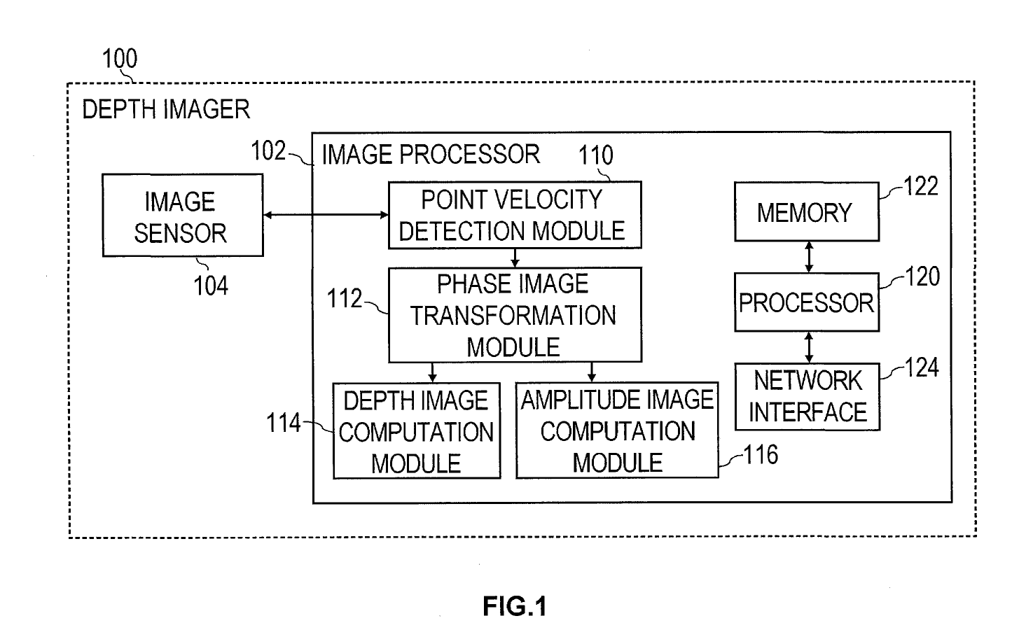

FIG. 1 shows a depth imager 100 in an embodiment of the invention. The depth imager 100 comprises an image processor 102 that receives raw depth images from an image sensor 104. Although illustrated as a stand-alone device in the figure, the depth imager 100 is assumed to be part of a larger image processing system. For example, the depth imager 100 is generally configured to communicate with a computer or other processing device of such a system over a network or other type of communication medium.

Accordingly, depth images generated by the depth imager 100 can be provided to other processing devices for further processing in conjunction with implementation of functionality such as gesture recognition. Such depth images can additionally or alternatively be displayed, transmitted or stored using a wide variety of conventional techniques.

Moreover, the depth imager 100 in some embodiments may be implemented on a common processing device with a computer, mobile phone or other device that processes depth images. By way of example, a computer or mobile phone may be configured to incorporate the image processor 102 and image sensor 104.

The depth imager 100 in the present embodiment is more particularly assumed to be implemented in the form of a ToF camera configured to generate depth images using the motion compensation techniques disclosed herein, although other implementations such as an SL camera implementation or a multiple 2D camera implementation may be used in other embodiments. A given depth image generated by the depth imager 100 may comprise not only depth data but also intensity or amplitude data with such data being arranged in the form of one or more rectangular arrays of pixels.

The image processor 102 of depth imager 100 illustratively comprises a point velocity detection module 110, a phase image transformation module 112, a depth image computation module 114 and an amplitude image computation module 116. The image processor 102 is configured to obtain from the image sensor 104 multiple phase images for each of first and second depth frames in a sequence of depth frames.

For each of the pixels of a given one of the phase images of the first depth frame, the point velocity detection module 110 of image processor 102 determines an amount of movement of a point of an imaged scene between the pixel of the given phase image and a pixel of a corresponding phase image of the second depth frame, and phase image transformation module 112 adjusts pixel values of respective other phase images of the first depth frame based on the determined amount of movement.

A motion compensated first depth image is then generated by the depth image computation module 114 utilizing the given phase image and the adjusted other phase images of the first depth frame. As will be described in more detail below, movement of a point of the imaged scene may be determined, for example, between pixels of respective n-th phase images of the first and second depth frames.

In conjunction with generation of the motion compensated first depth image in module 114, a motion compensated first amplitude image corresponding to the first depth image is generated in amplitude image computation module 116, also utilizing the given phase image and the adjusted other phase images of the first depth frame.

The resulting motion compensated first depth image and its associated motion compensated first amplitude image is then subject to additional processing operations in the image processor 102 or in another processing device. Such additional processing operations may include, for example, storage, transmission or image processing of the motion compensated first depth image.

It should be noted that the term “depth image” as broadly utilized herein may in some embodiments encompass an associated amplitude image. Thus, a given depth image may comprise depth data as well as corresponding amplitude data. For example, the amplitude data may be in the form of a grayscale image or other type of intensity image that is generated by the same image sensor 104 that generates the depth data. An intensity image of this type may be considered part of the depth image itself, or may be implemented as a separate intensity image that corresponds to or is otherwise associated with the depth image. Other types and arrangements of depth images comprising depth data and having associated amplitude data may be generated in other embodiments.

Accordingly, references herein to a given depth image should be understood to encompass, for example, an image that comprises depth data only, as well as an image that comprises a combination of depth and amplitude data. The depth and amplitude images mentioned previously in the context of the description of modules 114 and 116 need not comprise separate images, but could instead comprise respective depth and amplitude portions of a single image.

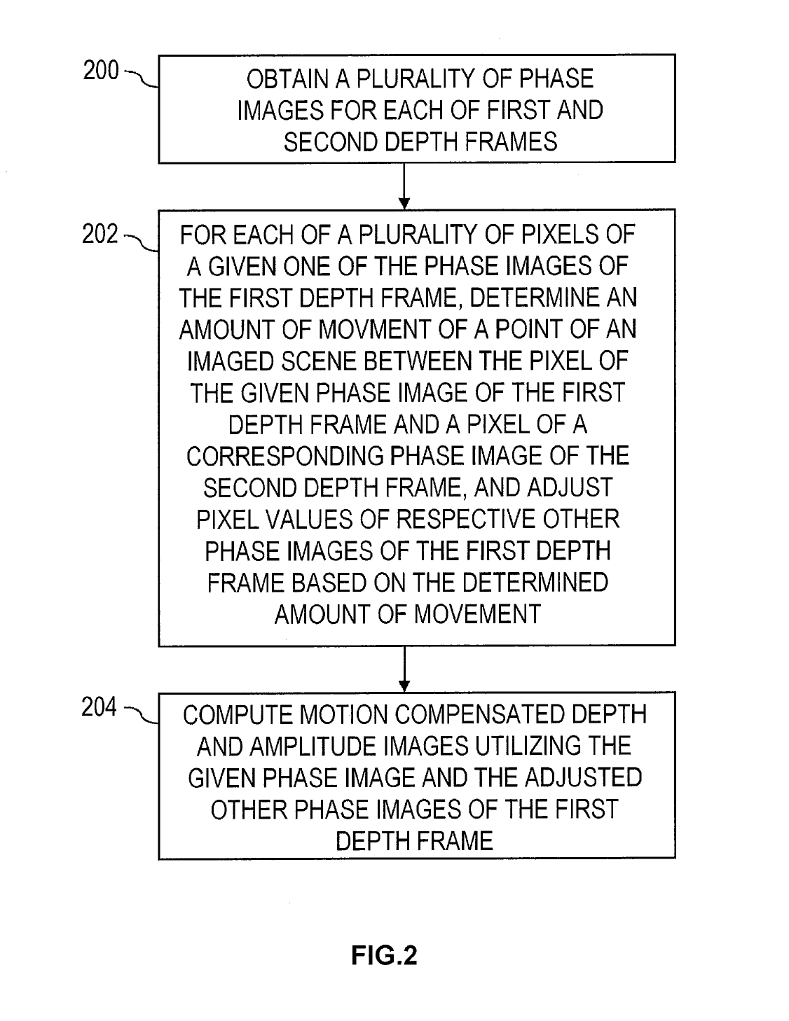

The operation of the modules 110, 112, 114 and 116 of image processor 102 will be described in greater detail below in conjunction with reference to FIGS. 2 through 6.

The particular number and arrangement of modules shown in image processor 102 in the FIG. 1 embodiment can be varied in other embodiments. For example, in other embodiments two or more of these modules may be combined into a lesser number of modules, or the disclosed motion compensation functionality may be distributed across a greater number of modules. An otherwise conventional image processing integrated circuit or other type of image processing circuitry suitably modified to perform processing operations as disclosed herein may be used to implement at least a portion of one or more of the modules 110, 112, 114 and 116 of image processor 102.

Motion compensated depth and amplitude images generated by the respective computation modules 114 and 116 of the image processor 102 may be provided to one or more other processing devices or image destinations over a network or other communication medium. For example, one or more such processing devices may comprise respective image processors configured to perform additional processing operations such as feature extraction, gesture recognition and automatic object tracking using motion compensated images that are received from the image processor 102. Alternatively, such operations may be performed in the image processor 102.

The image processor 102 in the present embodiment is assumed to be implemented using at least one processing device and comprises a processor 120 coupled to a memory 122. The processor 120 executes software code stored in the memory 122 in order to control the performance of image processing operations, including operations relating to depth image motion compensation.

The image processor 102 in this embodiment also illustratively comprises a network interface 124 that supports communication over a network, although it should be understood that an image processor in other embodiments of the invention need not include such a network interface. Accordingly, network connectivity provided via an interface such as network interface 124 should not be viewed as a requirement of an image processor configured to perform motion compensation as disclosed herein. The processor 120 may comprise, for example, a microprocessor, an application-specific integrated circuit (ASIC), a field-programmable gate array (FPGA), a central processing unit (CPU), an arithmetic logic unit (ALU), a digital signal processor (DSP), or other similar processing device component, as well as other types and arrangements of image processing circuitry, in any combination.

The memory 122 stores software code for execution by the processor 120 in implementing portions of the functionality of image processor 102, such as portions of modules 110, 112, 114 and 116. A given such memory that stores software code for execution by a corresponding processor is an example of what is more generally referred to herein as a computer-readable medium or other type of computer program product having computer program code embodied therein, and may comprise, for example, electronic memory such as random access memory (RAM) or read-only memory (ROM), magnetic memory, optical memory, or other types of storage devices in any combination. As indicated above, the processor may comprise portions or combinations of a microprocessor, ASIC, FPGA, CPU, ALU, DSP or other image processing circuitry.

It should also be appreciated that embodiments of the invention may be implemented in the form of integrated circuits. In a given such integrated circuit implementation, identical die are typically formed in a repeated pattern on a surface of a semiconductor wafer. Each die includes an image processor or other image processing circuitry as described herein, and may include other structures or circuits. The individual die are cut or diced from the wafer, then packaged as an integrated circuit. One skilled in the art would know how to dice wafers and package die to produce integrated circuits. Integrated circuits so manufactured are considered embodiments of the invention.

The particular configuration of depth imager 100 as shown in FIG. 1 is exemplary only, and the depth imager 100 in other embodiments may include other elements in addition to or in place of those specifically shown, including one or more elements of a type commonly found in a conventional implementation of such an imager.

For example, in some embodiments, the depth imager 100 may be installed in a video gaming system or other type of gesture-based system that processes image streams in order to recognize user gestures. The disclosed techniques can be similarly adapted for use in a wide variety of other systems requiring a gesture-based human-machine interface, and can also be applied to applications other than gesture recognition, such as machine vision systems in robotics and other industrial applications.

Referring now to FIG. 2, an exemplary flow diagram is shown illustrating a motion compensation process implemented in the image processor 102. The process includes steps 200, 202 and 204 as shown. Step 200 is assumed to be implemented using a conventional depth frame acquisition component of the image processor 102 that is not explicitly illustrated in FIG. 1. Step 202 is performed using modules 110 and 112, and step 204 is performed using modules 114 and 116.

As indicated previously, portions of the process may be implemented at least in part utilizing software executing on image processing hardware of the image processor 102.

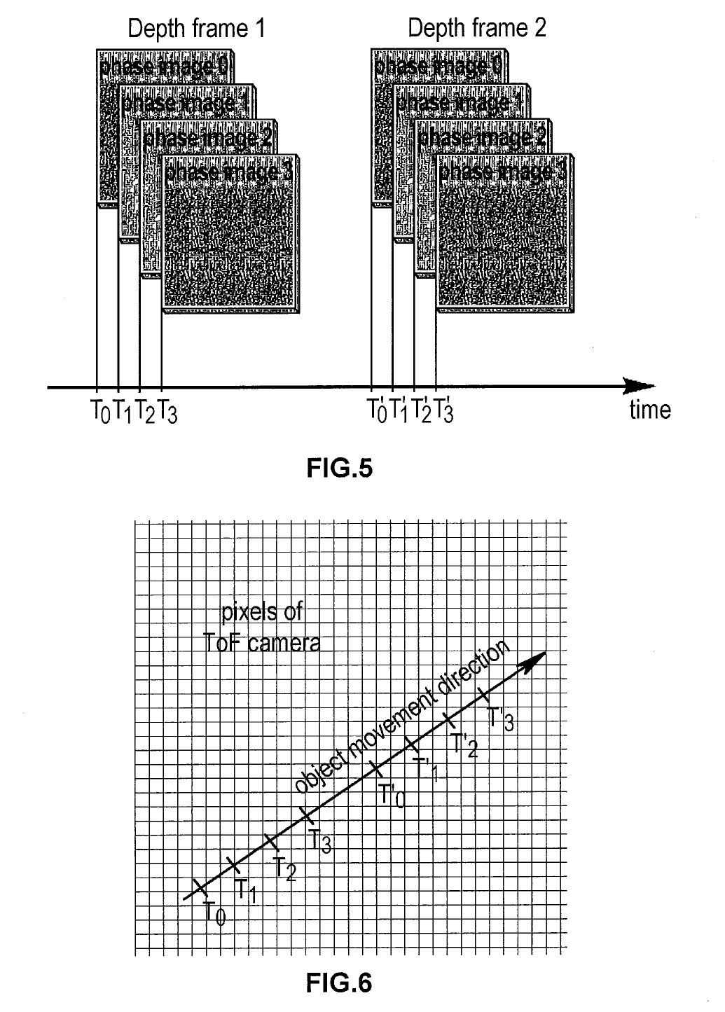

It is further assumed in this embodiment that a given depth frame received by the image processor 102 from the image sensor comprises multiple phase images. Moreover, the image sensor 104 captures a sequence of depth frames of an imaged scene, with each such depth frame comprising multiple phase images. By way of example, each of the first and second depth frames may comprise a sequence of four phase images each having a different capture time, as illustrated in FIG. 5.

In step 200, a plurality of phase images are obtained for each of first and second depth frames.

In step 202, for each of a plurality of pixels of a given one of the phase images of the first depth frame, an amount of movement of a point of an imaged scene between the pixel of the given phase image of the first depth frame and a pixel of a corresponding phase image of the second depth frame is determined, and pixel values of respective other phase images of the first depth frame are adjusted based on the determined amount of movement.

Determining an amount of movement for a particular pixel may comprise, for example, determining an amount of movement of a point of an imaged scene between a pixel of an n-th one of the phase images of the first depth frame and a pixel of an n-th one of the phase images of the second depth frame. As a more particular example, determining an amount of movement may comprise determining an amount of movement of a point of the imaged scene between a pixel of an initial one of the phase images of the first depth frame and a pixel of an initial one of the phase images of the second depth frame.

Adjusting pixel values of respective other phase images of the first depth frame in some embodiments comprises transforming the other phase images such that the point of the imaged scene has substantially the same pixel coordinates in each of the phase images of the first depth frame. This may more particularly involve, for example, moving values of the pixels of respective other phase images to positions within those images corresponding to a position of the pixel in the given phase image. Such movement of the pixel values can create gaps corresponding to “empty” pixels, also referred to herein as “missed” pixels, examples of which are illustrated by the gray pixels in FIG. 4 as will be described in more detail below. For any such missed pixels that result from movement of the corresponding pixel values, the corresponding gaps can be filled or otherwise repaired by assigning replacement values to the pixels for which values were moved. The assignment of replacement values may be implemented, for example, by assigning the replacement values as predetermined values, by assigning the replacement values based on values of corresponding pixels in a phase image of at least one previous or subsequent depth frame, or by assigning the replacement values as a function of a plurality of neighboring pixel values within the same phase image. Various combinations of these and other assignment techniques may also be used.

The determining and adjusting operations of step 202 may be repeated for substantially all of the pixels of the given phase image that are associated with a particular object of the imaged scene. This subset of the set of total pixels of the given phase image may be determined based on definition of a particular region of interest (ROI) within that phase image. It is also possible to repeat the determining and adjusting operations of step 202 for substantially all of the pixels of the given phase image.

Other arrangements can be used in other embodiments. For example, the movement may be determined relative to arbitrary moments in time and all of the phase images can be adjusted based on the determined movement.

In step 204, a motion compensated first depth image is generated utilizing the given phase image and the adjusted other phase images of the first depth frame, and a motion compensated first amplitude image corresponding to the first depth image is also generated utilizing the given phase image and the adjusted other phase images of the first depth frame.

The steps 200, 202 and 204 of the FIG. 2 process are repeated for additional pairs of depth frames of a sequence of depth frames captured by the image sensor 104.

As noted above, the depth imager 100 is assumed to utilize ToF techniques to generate depth images. In some embodiments, the ToF functionality of the depth imager is implemented utilizing a light emitting diode (LED) light source which illuminates an imaged scene. Distance is measured based on the time difference between the emission of light onto the scene from the LED source and the receipt at the image sensor 104 of corresponding light reflected back from objects in the scene. Using the speed of light, one can calculate the distance to a given point on an imaged object for a particular pixel as a function of the time difference between emitting the incident light and receiving the reflected light. More particularly, distance d to the given point can be computed as follows:

$$d = \frac{Tc}{2}$$

where T is the time difference between emitting the incident light and receiving the reflected light, c is the speed of light, and the constant factor 2 is due to the fact that the light passes through the distance twice, as incident light from the light source to the object and as reflected light from the object back to the image sensor.

The time difference between emitting and receiving light may be measured, for example, by using a periodic light signal, such as a sinusoidal light signal or a triangle wave light signal, and measuring the phase shift between the emitted periodic light signal and the reflected periodic signal received back at the image sensor.

Assuming the use of a sinusoidal light signal, the depth imager 100 can be configured, for example, to calculate a correlation function c(τ) between input reflected signal s(t) and output emitted signal g(t) shifted by predefined value τ, in accordance with the following equation:

$$c ( τ ) = {lim}_{T \to ∞} \frac{1}{T} {\int }_{T / 2}^{- T / 2} s ( t ) g ( t + τ ) d t$$

In such an embodiment, the depth imager 100 is more particularly configured to utilize multiple phase images, corresponding to respective predefined phase shifts τₙ given by 2, where n=0, . . . , 3. Accordingly, in order to compute depth and amplitude values for a given image pixel, the depth imager obtains four correlation values (A₀, . . . , A₃), where Aₙ=c(τₙ), and uses the following equations to calculate phase shift φ and amplitude a:

$$ϕ = arctan ( \frac{{A}_{3} - {A}_{1}}{{A}_{0} - {A}_{2}} )$$

$$a = \frac{1}{2} √ {( {A}_{3} - {A}_{1} )}^{2} + {( {A}_{0} - {A}_{2} )}^{2}$$

The phase images in this embodiment comprise respective sets of A₀, A₁, A₂ and A₃ correlation values computed for a set of image pixels. Using the phase shift φ, distance d can be calculated for a given image pixel as follows:

$$d = \frac{c}{4 πω} ϕ$$

where ω is the frequency of emitted signal and c is the speed of light. These computations are repeated to generate depth and amplitude values for other image pixels.

The correlation function above is computed over a specified integration time, which may be on the order of about 0.2 to 2 milliseconds (ms). Short integration times can lead to noisy phase images, while longer ones can lead to issues with image distortion, such as blurring. Taking into account the time needed to transfer phase image data from the image sensor 104 to internal memory of the image processor 102, a full cycle for collecting all four correlation values may take up to 20 ms or more.

To summarize, in the embodiment described above, in order to obtain a depth value for a given image pixel, the depth imager 100 obtains four correlation values A₀, . . . , A₃ which are calculated one by one, with the time between these calculations usually being about 1 to 5 ms depending on integration time and the time required to transfer phase image data from the image sensor to the internal memory.

The use of multiple correlation values obtained over time in the manner described above can be problematic in the presence of fast movement of objects within an imaged scene. As mentioned previously, “fast” in this context refers to movement that occurs on a time scale that is less than the time between generation of consecutive depth images at a given frame rate. The phase images are captured at different times, leading to motion blur and other types of motion artifacts in the presence of fast movement of objects. This corrupts the raw data used for depth and amplitude calculations, preventing accurate generation of depth values for certain pixels of the depth image.

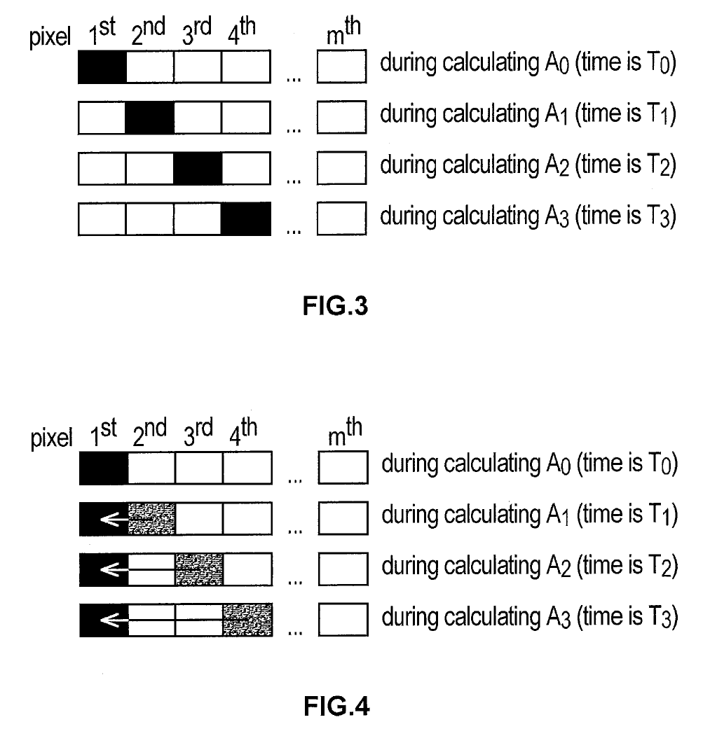

For example, if an object is moving fast in an imaged scene, a given pixel may correspond to different points on the moving object in different ones of the four phase images. This is illustrated in FIG. 3, which shows movement of an exemplary point in an imaged scene over multiple sequential capture times for respective phase images of a depth frame. In this particular simplified example, a one-pixel object is shown in black and moves from left to right against a static background within a row of image pixels. The object position is represented by a black pixel, while background is represented by white pixels. The one-pixel object moves at a speed of one pixel per time period T, where T is the time between acquisition of consecutive correlation values Aᵢ, that is, between acquisition of correlation values Aᵢ and Aᵢ₊₁. In the figure, the object is in a first pixel position of a row of m pixels during calculation of A₀ at time T₀ but as a result of its fast movement in the imaged scene, is in the second pixel position during calculation of A₁ at time T₁, is in the third pixel position during calculation of A₂ at time T₂, and is in the fourth pixel position during calculation of A₃ at time T₃.

If the above-described equations for phase and amplitude are applied to the resulting four correlation values A₀, . . . , A₃ of FIG. 3, it is apparent that incorrect depth and amplitude values will result, as only the first correlation value A₀ will actually measure the object in the first pixel position, while each of the other three correlation values will measure static background in that first pixel position. The depth and amplitude values will be in error for all of the calculated correlation values. This is an example of motion blur that can occur when using ToF techniques that capture depth frames as a sequence of multiple phase images.

In the present embodiment, the depth imager 100 compensates for this type of motion blur by determining the movement of a point in an imaged scene, and adjusting pixel values to compensate for the movement. With reference to FIG. 4, the depth imager 100 determines that the one-pixel object is moving in the manner previously described, and compensates for this motion by adjusting pixel values such that the one-pixel object always appears in the first pixel position as illustrated.

This operation may be viewed as reverting the time of the black pixel for the last three phase images such that each phase image acquires the black pixel in the first pixel position. This reversion in time of the black pixel causes information in the gray pixels to be missed when calculating A₁, A₂ and A₃, but that information can be copied from a previous or subsequent depth frame, or copied as a function of values of neighboring pixels. Alternatively, the corresponding gray pixel positions can be marked as invalid using respective flags.

In the FIG. 4 example, correct depth and amplitude values are determined for both the one-pixel object and the static background, assuming appropriate correction of the gray pixels in the second, third and fourth pixel positions.

The embodiment described in conjunction with FIGS. 3 and 4 can be extended in a straightforward manner to more complex objects. For example, the image processor 102 utilizing modules 110, 112, 114 and 116 can determine the movement of multiple points in an imaged scene between two or more phase images, and adjust pixel values to compensate for the determined movement of each point. As mentioned previously, in some embodiments, movement is determined between a given phase image of one depth frame and a corresponding phase image of another depth frame, although other arrangements can be used. Also, the term “point” as used herein in the context of an imaged scene may refer to any identifiable feature or characteristic of the scene, or portion of such a feature or characteristic, for which movement can be tracked across multiple phase images.

Referring now to FIG. 5, first and second consecutive depth frames are shown, denoted as Depth Frame 1 and Depth Frame 2. Each such depth frame comprises four phase images, denoted as Phase Image 0 through Phase Image 3. The phase images of the first depth frame are acquired at respective times T₀, T₁, T₂ and T₃, while the phase images of the second depth frame are acquired at respective times T₀′, T₁′, T₂′ and T3′. It should be noted that this particular arrangement of depth frames and phase images is presented by way of illustrative example only, and should not be construed as limiting in any way. For example, in other embodiments depth frames may include more than four or less than four phase images. Also, the particular type and arrangement of information contained in a given phase image may vary from embodiment to embodiment. Accordingly, terms such as “depth frame” and “phase image” as used herein are intended to be broadly construed.

Movement of an exemplary point in an imaged scene between the phase images of the first and second depth frames is illustrated in FIG. 6. The grid in this figure represents the pixels of image sensor 104 in a ToF camera implementation of the depth imager 100, and the arrow shows the object movement direction across the pixels as a function of the acquisition times of the respective phase images. The term “acquisition time” as used herein is intended to be broadly construed, and may refer, for example, to a particular instant in time at which capture of a given phase image is completed, or to a total amount of time required to capture the phase image. The acquisition time is referred to elsewhere herein as “capture time,” which is also intended to be broadly construed.

A process of the type previously described in FIG. 2 but more particularly adapted to the scenario of FIGS. 5 and 6 may be implemented as follows.

Step 1. For each pixel of the first phase image find the corresponding pixels on all other phase images.

Step 2. For each phase image other the first phase image, transform the phase image in such a way that each pixel corresponding to a pixel with coordinates (x,y) in the first phase image will have the same coordinates (x,y) in the other phase image.

Step 3. Fill any missed (e.g., empty) pixels for each phase image using data from the same phase image of the previous depth frame or from averaged phase images of the previous depth frame.

Step 4. Calculate the depth and amplitude values for respective pixels of the motion compensated depth frame comprising the transformed phase images, using the equations given above.

Step 5. Apply filtering to suppress noise.

It should be noted that the above steps are exemplary only, and may be varied in other embodiments. For example, in other embodiments, different techniques may be used to fill missing pixels in the phase images, or the noise suppression filtering may be eliminated.

Each of the steps of the exemplary process above will now be described in more detail.

Step 1. Finding pixel correspondence.

As mentioned previously, the depth imager 100 in some embodiments is assumed to utilize ToF techniques to acquire four phase images for each depth frame. The integration time for acquisition of a given phase image is about 0.2 to 2 ms, the time period Tᵢ₊₁−Tᵢ between two consecutive phase images of a depth frame is about 1 to 5 ms, and the time period T₀′−T₀ To between two consecutive depth frames is about 10 to 20 ms.

In some embodiments, an optical flow algorithm is used to find movement between pixels of corresponding phase images of consecutive depth frames. For example, for each pixel of the n-th phase image of the first depth frame, the optical flow algorithm finds the corresponding pixel of the n-th phase image of the second depth frame. The resulting motion vector is referred to herein as a velocity vector for the pixel.

It was noted above that FIG. 6 illustrates the movement of a given object point across pixels in different phase images as a function of time. There are four pairs of corresponding phase images in the two depth frames shown in this figure and all these phase images represent the same imaged scene. The arrow in the figure may be viewed as an example of the above-noted velocity vector. This velocity vector is generated based on an assumption that the movement of the particular object point in the image is straight and uniform over the total acquisition time of the corresponding two depth frames.

More particularly, it can be assumed that Tₙ=T₀+nΔt and Tₙ′=Tₙ+ΔT, where Δt is the time between two consecutive phase images and ΔT is the time between two consecutive depth frames. The notation Iₙ(x,y,t) is used below to denote the value of pixel (x,y) in the n-th phase image at time t.

Under the further assumption that the value of Iₙ(x,y,t) for each tracked point does not significantly change over the time period of two depth frames, the following equation can be used to determine the velocity of the point:

Iₙ(x+nVₓΔt,y+nV_{y}Δt,t+nΔt)==Iₙ(x+Vₓ(ΔT+nΔt),y+Vⱼ(ΔT+nΔt),t+ΔT+nΔT)

where (Vₓ, V_{y}) denotes an unknown point velocity. Using Taylor series for both the left and right sides of the above equation results in the following equation for optical flow, specifying a linear system of four equations for respective values of n=0, . . . , 3:

$$\frac{\partial {I}_{n}}{\partial x} {V}_{x} + \frac{\partial {I}_{n}}{\partial y} {V}_{y} + \frac{\partial {I}_{n}}{\partial t} = 0$$

This system of equations can be solved using least squares or other techniques commonly utilized to solve optical flow equations, including by way of example pyramid methods, local or global additional restrictions, etc. A more particular example of a technique for solving an optical flow equation of the type shown above is the Lukas-Kanade algorithm, although numerous other techniques can be used.

Step 2. Phase image transformation.

After the correspondence between pixels in different phase images is found, all of the phase images except for the first phase image are transformed in such a way that corresponding pixels have the same coordinates in all phase images.

Assume by way of example that movement of a given point has been determined as a velocity for pixel (x,y) of the first phase image and the value of this velocity is (Vₓ, V_{y}). With reference to FIG. 6, this means that if the point has coordinates (x,y) at time T₀, then at time T₀′ its coordinates will be (x+Vₓ, y+V_{y}) and at time Tₙ its coordinates will be (x+Vₓ·n·Δt/ΔT, y+V_{y}·n·Δt/ΔT). Accordingly, transformation of the phase images other than the first phase image can be implemented by constructing corrected phase images Jₙ(x,y), where

Jₙ(x,y)=Iₙ(x+Vₓ·n·Δt/ΔT,y+V_{y}·n·Δt/ΔT)

In this example, the first phase image acquired at time T₀ is the phase image relative to which the other phase images are transformed to provide the desired motion compensation. However, in other embodiments any particular one of the phase images can serve as the reference phase image relative to which all of the other phase images are transformed.

Also, the above-described phase image transformation can be straightforwardly generalized to any moment in time. Accordingly, the acquisition time of the n-th phase image is utilized in the present embodiment by way of example only, although in some cases it may also serve to slightly simplify the computation. Other embodiments can therefore be configured to transform all of the phase images, rather than all of the phase images other than a reference phase image. Recitations herein relating to use of a given phase image to generate a motion compensated depth image are therefore intended to be construed broadly so as to encompass use of an adjusted or unadjusted version of the given phase image, in conjunction with an adjusted version of at least one other phase image.

It should be also noted that some pixels of Jₙ(x,y) may be undefined after completion of Step 2. For example, the corresponding pixel may have left the field of view of the depth imager 100, or an underlying object may become visible after a foreground object is moved.

Step 3. Filling the missed pixels.

As mentioned above, some pixels may be undefined after completion of Step 2. Any of a wide variety of techniques can be used to address these missed pixels. For example, one or more such pixels can each be set to a predefined value and a corresponding flag set to indicate that the data in that particular pixel is invalid and should not be used in computation of depth and amplitude values.

As another example, the image processor 102 can store previous frame information to be used in repairing missed pixels. This may involve storing a single previous frame and substituting all missed pixels in the current frame with respective corresponding values from the previous frame. Averaged depth frames may be used instead, and stored and updated by the image processor 102 on a regular basis.

It is also possible to use various filtering techniques to fill the missed pixels. For example, an average value of multiple valid neighboring pixels may be used.

Again, the above missed pixel filling techniques are just examples, and other techniques or combinations of multiple techniques may be used.

After completion of the Step 3 portion of the process, all phase images either do not contain any invalid pixels, or include special flags set for invalid pixels. Step 4. Calculating the depth and amplitude values.

This step can be implemented in a straightforward manner using the equations described elsewhere herein to compute depth and amplitude values from the phase images containing the correlation values.

Step 5. Filtering of depth and amplitude images.

In order to increase the quality of the depth and amplitude images, the computation modules 114 and 116 can implement various types of filtering. This may involve, for example, use of smoothing filters, bilateral filters, or other types of filters. Again, such filtering is not a requirement, and can be eliminated in other embodiments.

At least portions of the above-described process can be pipelined in a straightforward manner. For example, certain processing steps can be executed at least in part in parallel with one another, thereby reducing the overall latency of the process for a given depth image, and facilitating implementation of the described techniques in real-time image processing applications. Also, vector processing in firmware can be used to accelerate at least portions of one or more of the process steps.

It is also to be appreciated that the particular processing operations used in the embodiment of FIG. 2 and other embodiments described above are exemplary only, and alternative embodiments can utilize different types and arrangements of image processing operations. For example, the particular techniques used to determine movement of a point of an imaged scene and for transforming phase images of a depth frame based on the determined movement can be varied in other embodiments. Also, as noted above, one or more processing blocks indicated as being executed serially in the figure can be performed at least in part in parallel with one or more other processing blocks in other embodiments.

Moreover, other embodiments of the invention can be adapted for providing motion compensation for only depth data associated with a given depth image or sequence of depth images. For example, with reference to the process of FIG. 2, portions of the process associated with amplitude data processing can be eliminated in embodiments in which a 3D image sensor outputs only depth data and not amplitude data. Accordingly, the processing of amplitude data in FIG. 2 and elsewhere herein may be viewed as optional in other embodiments.

Embodiments of the invention such as those illustrated in FIGS. 1 and 2 provide particularly efficient techniques for compensating for fast object motion in depth images. For example, these techniques can provide significantly better depth image quality in the presence of fast object motion than conventional techniques.

It should again be emphasized that the embodiments of the invention as described herein are intended to be illustrative only. For example, other embodiments of the invention can be implemented utilizing a wide variety of different types and arrangements of image processing circuitry, modules and processing operations than those utilized in the particular embodiments described herein. In addition, the particular assumptions made herein in the context of describing certain embodiments need not apply in other embodiments. These and numerous other alternative embodiments within the scope of the following claims will be readily apparent to those skilled in the art.

1. A method comprising:
obtaining a plurality of phase images for each of first and second depth frames;
for each of a plurality of pixels of a given one of the phase images of the first depth frame:
determining an amount of movement of a point of an imaged scene between the pixel of the given phase image of the first depth frame and a pixel of a corresponding phase image of the second depth frame; and
adjusting pixel values of respective other phase images of the first depth frame based on the determined amount of movement;
wherein a motion compensated first depth image is generated utilizing the given phase image and the adjusted other phase images of the first depth frame; and
wherein said obtaining, determining and adjusting are implemented in at least one processing device comprising a processor coupled to a memory.

2. The method of claim 1 wherein the pluralities of phase images for respective ones of the first and second depth frames comprise respective sequences of at least four phase images each having a different capture time.

3. The method of claim 1 wherein the determining and adjusting are repeated for substantially all of the pixels of the given phase image that are associated with a particular object of the imaged scene.

4. The method of claim 1 wherein determining an amount of movement comprises determining an amount of movement of a point of an imaged scene between a pixel of an n-th one of the phase images of the first depth frame and a pixel of an n-th one of the phase images of the second depth frame.

5. The method of claim 4 wherein determining an amount of movement comprises determining an amount of movement of a point of the imaged scene between a pixel of an initial one of the phase images of the first depth frame and a pixel of an initial one of the phase images of the second depth frame.

6. The method of claim 4 wherein determining an amount of movement comprises solving an equation of the following form:
Iₙ(x+nVₓΔt,y+nV_{y}Δt,t+nΔt)−=Iₙ(x|Vₓ(ΔT|nΔt),y|V_{y}(ΔT|nΔt),t |ΔT|nΔT)
to determine a velocity (Vₓ, V_{y}) of the point of the imaged scene, where Iₙ(x,y,t) denotes the value of pixel (x,y) of the n-th phase image at time t, Δt denotes the time between two consecutive phase images of a given one of the first and second depth frames, and ΔT denotes the time between the first and second depth frames.

7. The method of claim 6 wherein solving the equation comprises solving a system of multiple equations of the form:
$$\frac{\partial {I}_{n}}{\partial x} {V}_{x} + \frac{\partial {I}_{n}}{\partial y} {V}_{y} + \frac{\partial {I}_{n}}{\partial t} = 0$$
for respective ones of the phase images of the first and second depth frames.

8. The method of claim 1 wherein adjusting pixel values of respective other phase images of the first depth frame comprises transforming the other phase images such that the point of the imaged scene has substantially the same pixel coordinates in each of the phase images of the first depth frame.

9. The method of claim 1 wherein adjusting pixel values of respective other phase images of the first depth frame comprises:
moving values of the pixels of respective other phase images to positions within those images corresponding to a position of the pixel in the given phase image; and
assigning replacement values to the pixels for which values were moved.

10. The method of claim 9 wherein assigning replacement values comprises at least one of:
assigning the replacement values as predetermined values;
assigning the replacement values based on values of corresponding pixels in a phase image of at least one previous or subsequent depth frame; and
assigning the replacement values as a function of a plurality of neighboring pixel values within the same phase image.

11. The method of claim 1 further comprising:
generating a motion compensated first amplitude image corresponding to the first depth image;
wherein the motion compensated first amplitude image is generated utilizing the given phase image and the adjusted other phase images of the first depth frame.

12. A computer-readable storage medium having computer program code embodied therein, wherein the computer program code when executed in the processing device causes the processing device to perform the method of claim 1.

13. An apparatus comprising:
at least one processing device comprising a processor coupled to a memory;
wherein said at least one processing device is configured:
to obtain a plurality of phase images for each of first and second depth frames;
for each of a plurality of pixels of a given one of the phase images of the first depth frame:
to determine an amount of movement of a point of an imaged scene between the pixel of the given phase image of the first depth frame and a pixel of a corresponding phase image of the second depth frame; and
to adjust pixel values of respective other phase images of the first depth frame based on the determined amount of movement;
wherein a motion compensated first depth image is generated utilizing the given phase image and the adjusted other phase images of the first depth frame.

14. The apparatus of claim 13 wherein said at least one processing device is implemented within a depth imager.

15. The apparatus of claim 14 wherein the depth imager comprises a ToF camera.

16. An integrated circuit comprising the apparatus of claim 13.

17. The integrated circuit of claim 16 wherein the integrated circuit is adapted for coupling to an image sensor of a depth imager.

18. A depth imager comprising:
an image sensor; and
an image processor coupled to the image sensor;
wherein the image processor is configured:
to obtain from the image sensor a plurality of phase images for each of first and second depth frames;
for each of a plurality of pixels of a given one of the phase images of the first depth frame:
to determine an amount of movement of a point of an imaged scene between the pixel of the given phase image of the first depth frame and a pixel of a corresponding phase image of the second depth frame; and
to adjust pixel values of respective other phase images of the first depth frame based on the determined amount of movement;
wherein a motion compensated first depth image is generated utilizing the given phase image and the adjusted other phase images of the first depth frame.

19. The depth imager of claim 18 wherein the depth imager comprises a ToF camera.

20. An image processing system comprising the depth imager of claim 18.
